(19) United States
(12) Patent Application Publication
(10) Pub. No.: US 2011/0131481 A1
(43) Pub. Date: Jun. 2, 2011

(54) DATA SAFETY FRAME

(75) Inventors: David Vronay, Beijing (CN); Yannis Paniaras, Beijing (CN); Li Qiao, Beijing (CN); Rebecca Jo Sundling, Seattle, WA (US)

(73) Assignee: Microsoft Corporation, Redmond, WA (US)

(21) Appl. No.: 12/628,232

(22) Filed: Dec. 1, 2009

(51) Int. Cl. G06F 17/00; G06F 3/048

(52) U.S. Cl. 715/227; 715/781

(57) ABSTRACT

A data safety frame user interface control is provided that visually indicates the presence and location of off-screen data to a user. The data safety frame user interface control can also visually indicate the presence and location of special data that is off-screen. The data safety frame user interface control can also be utilized to quickly navigate to the off-screen data.

### BACKGROUND

Various types of software programs provide functionality for viewing and editing tabular data. For instance, spreadsheet application programs provide various mechanisms for viewing and editing tabular data. When viewing large data sets, these types of programs typically present only a portion of the tabular data on-screen at a time. User interface controls are generally provided that allow a user to view the off-screen portion of the data. As one example, a spreadsheet application program might provide traditional scroll bar user interface (“UI”) controls so that a user can navigate to the off-screen portions of a large spreadsheet.

Certain types of spreadsheets are both very large and very sparse. In some cases, a spreadsheet might have hundreds or even thousands of empty rows or columns between one data point and the next. Traditional UI controls for navigating tabular data prove cumbersome to use with these types of data sets. Navigating this type of data set cell-by-cell can be very difficult and traditional scroll bar UI controls can be inaccurate.

In many types of tabular data there are also special values that are important not to miss. These types of values might be colored red in a traditional spreadsheet. It could be extremely important for a user to be aware that these types of values exist in a data set. If these values are off-screen, however, they may be quite easy to miss, especially in a very large and very sparse data set.

While each of the shortcomings of previous UI controls for navigating tabular data described above can apply to any type of tabular data, these shortcomings become especially problematic in conjunction with medical data. Missing a special value in a data set containing medical data, such as an abnormal medical test result, could literally be a matter of life and death.

It is with respect to these and other considerations that the disclosure made herein is presented.

### SUMMARY

Concepts and technologies are described herein for visualizing and navigating tabular data. Through an implementation of the concepts and technologies presented herein, a data safety frame UI control is provided that visually indicates the presence and location of off-screen tabular data to a user. The data safety frame UI control can also visually indicate the presence and location of special tabular data that is off-screen. The data safety frame UI control can also be utilized to quickly navigate to the off-screen tabular data. Through the use of the data safety frame UI control in this manner, a user is less likely to miss off-screen data when viewing tabular data.

According to one aspect presented herein, a data safety frame UI control is provided that visually indicates the presence and location of standard and special tabular data that is off-screen and that can be utilized to navigate directly to the off-screen data. In various embodiments, the data safety frame UI control is utilized in conjunction with an application program configured to display a tabular data set, such as a spreadsheet, in a table having rows and columns. At any given time, a portion of the tabular data might be displayed and a portion of the tabular data might be off-screen and thereby undisplayed.

In order to indicate to a user that off-screen tabular data exists, the data safety frame UI control displays a visual indicator at the left side or right side of each row that has off-screen tabular data. A visual indicator is presented at the left side of the row if the row has undisplayed tabular data to the left of the displayed portion of the tabular data and is presented at the right side of the row if the row has undisplayed tabular data to the right of the displayed portion of the tabular data. The data safety frame UI control also displays a visual indicator at the top or bottom of each column that has off-screen tabular data. A visual indicator is presented at the top of a column if the column has undisplayed tabular data above the displayed portion of the tabular data and is presented at the bottom of the column if the column has undisplayed tabular data below the displayed portion of the tabular data.

According to various embodiments, the data safety frame UI control displays special visual indicators to indicate the presence of undisplayed special tabular data. For instance, the special visual indicators might be utilized to indicate the presence of undisplayed error values or abnormal values. In one implementation, a special visual indicator is presented at the left side of a row if the row has undisplayed special tabular data to the left of the displayed portion of the tabular data and is presented at the right side of the row if the row has undisplayed special tabular data to the right of the displayed portion of the tabular data. A special visual indicator is also presented at the top of a column if the column has undisplayed special tabular data above the displayed portion of the tabular data and is presented at the bottom of the column if the column has undisplayed special tabular data below the displayed portion of the tabular data.

According to embodiments, the visual indicators and special visual indicators can be selected, such as through the use of a mouse input device or another suitable user input device, in order to navigate to the undisplayed portion of the tabular data corresponding to the selected indicator. In particular, if a visual indicator is selected, the data safety frame UI control will cause a portion of the tabular data to be displayed that includes the next undisplayed tabular data for the row or column corresponding to the selected visual indicator in the direction of the selected visual indicator. If a special visual indicator is selected, the data safety frame UI control will cause a portion of the tabular data to be displayed that includes the undisplayed special tabular data for the row or column corresponding to the selected special visual indicator in the direction of the selected special visual indicator.

Although the various embodiments presented herein are described in the context of tabular data, it should be appreciated that the concepts and technologies presented herein might be utilized to indicate the presence of other types of off-screen data and to provide functionality for quickly navigating to that data. For instance, and without limitation, the concepts presented herein might be utilized with graphical images, such as maps, that are too large to be displayed on a single display screen. The embodiments disclosed herein might also be utilized with other types of data.

It should also be appreciated that the above-described subject matter might also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an operating environment for, and aspects of, several software components provided by various embodiments disclosed herein;

FIGS. 2-4 are user interface diagrams showing aspects of various user interfaces provided by the data safety frame UI control disclosed herein in various embodiments;

FIGS. 5A-5B are flow diagrams showing aspects of one process presented herein for visualizing and navigating tabular data utilizing a data safety frame UI control; and

FIG. 6 is a computer architecture diagram showing an illustrative computer hardware and software architecture for a computing system capable of implementing aspects of the embodiments presented herein.

### DETAILED DESCRIPTION

The following detailed description is directed to technologies for navigating and visualizing off-screen data. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system, computer-readable storage medium, and computer-implemented methodology for visualizing and navigating tabular data will be presented.

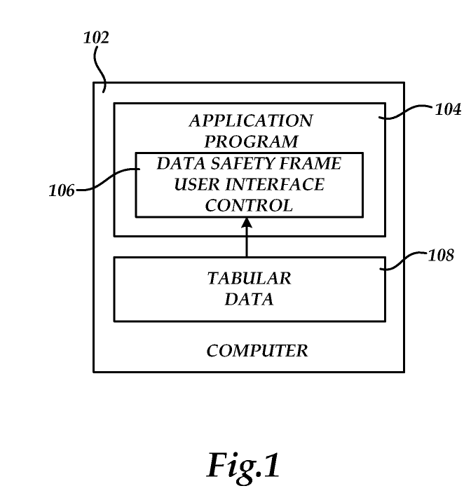

Referring now to FIG. 1, aspects of one operating environment for the various embodiments presented herein will be described. The operating environment shown in FIG. 1 includes a computer 102 configured to execute an application program 104. As discussed in greater detail below, the computer 102 may comprise a standard desktop or laptop personal computer system. Alternatively, the computer 102 may comprise a server computer, a hand held computer, an embedded computer system, a personal digital assistant, or virtually any other type of computing device known to those skilled in the art that is capable of executing an application program 104 for manipulating and editing tabular data.

Although the various embodiments described below are presented in the context of tabular data, it should be appreciated that the concepts and technologies presented herein might be utilized to indicate the presence of other types of off-screen data and to provide functionality for quickly navigating to that data. For instance, as discussed briefly above, the concepts presented herein might be utilized with graphical images, such as maps, that are too large to be displayed on a single display screen. The embodiments disclosed herein might also be utilized with other types of data.

According to one implementation, the application program 104 executes on the computer 102 in order to provide the functionality described herein for viewing the tabular data 108. According to embodiments, the application program 104 comprises a spreadsheet application program. It should be appreciated, however, that the application program 104 may comprise any type of program configured for allowing a user to view the tabular data 108. For instance, the application program 104 may comprise a word processing program, a presentation program, a program configured for viewing and interacting with medical data, a program configured for viewing and interacting with maps or other types of graphical images, and other types of programs.

According to various embodiments, the application program 104 provides functionality for displaying the tabular data 108 on a display device (not shown) of the computer 102. When the tabular data 108 is very large, the application program 104 also provides functionality for presenting only a portion of the tabular data 108 at a time. User interface controls may be provided by the application program 104 that allow a user of the computer 102 to change the portion of the tabular data 108 that is displayed on screen. In this manner, a user of the computer 102 can utilize these user interface controls in order to view all of the tabular data 108, even though only portions of the tabular data 108 may be presented at any given time.

In one implementation, the application program 104 provides traditional scroll bar UI controls that allow a user of the computer 102 to navigate to the off-screen portions of the tabular data 108. As an example, in one implementation the application program 104 comprises a spreadsheet application program and the tabular data 108 comprises a spreadsheet. In this example, the application program 104 may display only a portion of the tabular data 108 at any given time. In order to allow a user of the computer 102 to view other portions of the tabular data 108, the application program 104 may provide scroll bar UI controls that allow a user to scroll the display of the tabular data 108 in order to view all of the tabular data 108.

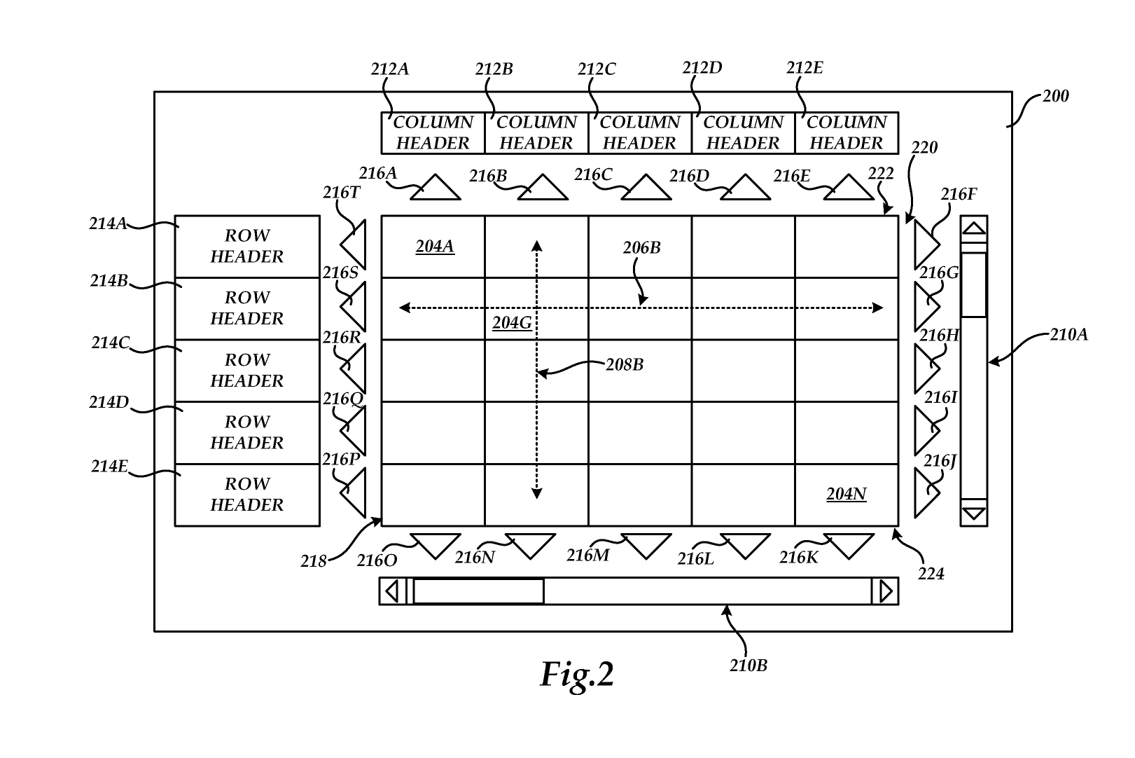

As discussed briefly above, however, certain types of tabular data 108 are both very large and very sparse. In this case, traditional UI controls such as scroll bar UI controls prove cumbersome to use and may be inaccurate. In order to address the shortcomings of traditional navigation UI controls, the embodiments disclosed herein provide a data safety frame UI control 106. As will be described in greater detail below, the data safety frame UI control 106 operates in conjunction with the application program 104 and provides functionality for visually indicating the presence and location of off-screen tabular data 108 to a user of the computer 102. According to various embodiments, the data safety frame UI control 106 can also visually indicate the presence and location of special tabular data that is off-screen, such as error values or abnormal values. The data safety frame UI control can also be utilized by a user of the computer 102 to quickly navigate to the portion of the tabular data 108 that is off-screen. Through the use of the data safety frame UI control 106, a user of the application program 104 is less likely to miss off-screen data than when using traditional navigation UI controls. Additional details regarding the functionality provided by the data safety frame UI control 106 will be provided below with respect to FIGS. 2-6.

It should be appreciated that, as disclosed herein, the tabular data 108 may comprise any type of data capable of being displayed in a tabular form. In one implementation, the tabular data 108 comprises a spreadsheet. However, other types of tabular data may be utilized with the embodiments presented herein. For instance, tabular data displayed in a table by a word processing program, a presentation application program, or an application for displaying medical information might also be utilized with the data safety frame UI control 106 presented herein.

Turning now to FIG. 2, a user interface diagram showing aspects of a user interface provided by the data safety frame UI control 106 in one embodiment will be described. In particular, FIG. 2 shows a screen display 200 generated by the application program 104 when utilized in conjunction with the data safety frame UI control 106.

The screen display 200 shown in FIG. 2 includes a number of rows 206, such as the row 206B, and a number of columns 208, such as the column 208B, for use in displaying the tabular data 108. As known in the art, the intersection of each row 206 and column 208 comprises a cell 204, such as the cell 204G at the intersection of the row 206B and the column 208B. Each of the cells 204A-204N may be utilized to display one or more values of the tabular data 108 in a conventional manner.

As also shown in FIG. 2, each of the columns 208 includes a column header 212A-212E for providing a text description of the contents of the respective column. Row headers 214A-214E may also be provided for each of the displayed rows 206 to provide a text description of the contents of the row in a similar fashion. Scroll bar UI controls 210A-210B may also be provided by the application program 104 for allowing the user of the computer 102 to navigate the displayed tabular data 108 in a conventional fashion.

According to various embodiments presented herein, the data safety frame UI control 106 is configured to display the visual indicators 216A-216T shown in FIG. 2. The visual indicators 216A-216E are displayed adjacent to the top 222 of the columns 208. The visual indicators 216F-216J are displayed adjacent to the right side 220 of the rows 206. The visual indicators 216K-216O are displayed adjacent to the bottom 224 of the columns 208. The visual indicators 216P-216T are displayed adjacent to the left side 218 of the rows 206.

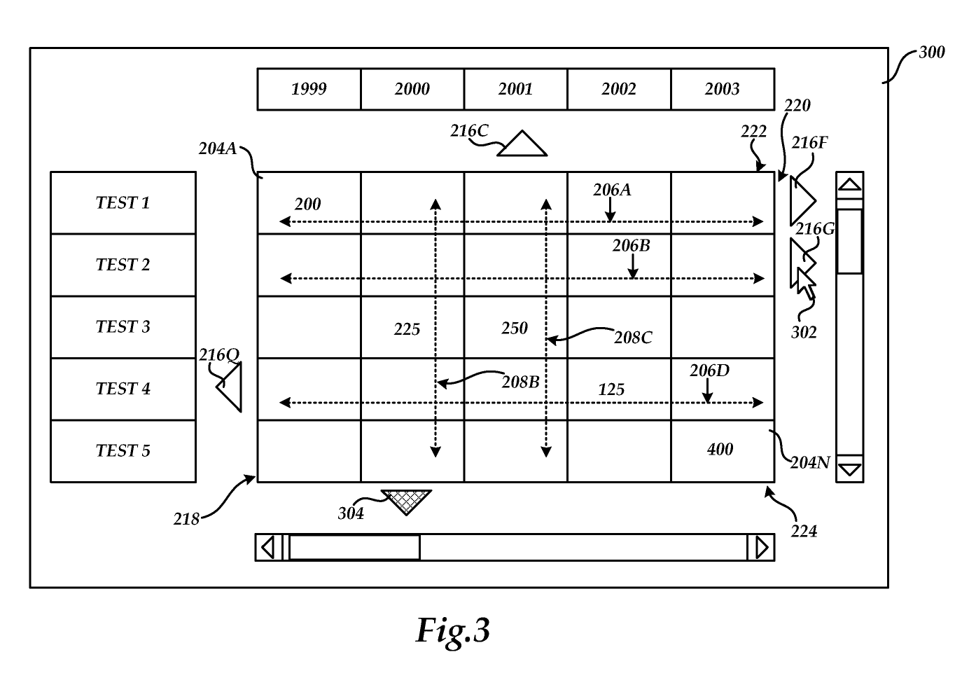

In one embodiment, the visual indicators 216A-216T are formed in the shape of arrows pointing away from the sides of the displayed tabular data 108. For instance, the visual indicators 216A-216E point away from the top 222 of the columns 208, the visual indicators 216F-216J point away from the right side 220 of the rows 206, the visual indicators 216K-216O point away from the bottom 224 of the columns 208, and the visual indicators 216P-216T point away from the left side 218 of the rows 206. In this manner, the visual indicators 216A-216T can be utilized to indicate the direction of undisplayed tabular data 108. That is, the visual indicators 216A-216T can be selectively presented in order to indicate to a user of the computer 102 that off-screen tabular data 108 exists for one or more of the rows 206 or columns 208 and the direction of the off-screen data. Additional details regarding this functionality will be provided below with respect to FIGS. 3-6.

It should be appreciated that although the visual indicators 216A-216T are shown in the FIGURES as being formed in the shape of arrows, other shapes may also be utilized. For instance, other geometric or arbitrary shapes may be utilized, text may be utilized, and other types of visual indicators may be utilized to indicate the existence and direction of undisplayed tabular data 108. Audible or other types of indicators may also be provided for use by visually impaired individuals. According to other implementations, information relevant to the off-screen data could be presented directly in the visual indicators. For instance, the visual indicators could indicate how far the off-screen data is off-screen or even the value of the data itself.

Turning now to FIG. 3, a screen display 300 generated by the application program 104 when utilized in conjunction with the data safety frame UI control 106 will be described. In the screen display 300 shown in FIG. 3, sample tabular data 108 has been displayed in the rows 206 and columns 208 by the application program 104. For instance, the cell 204A includes the value 200 and the cell 204N includes the value 400. Other cells illustrated in FIG. 3 include other values.

In the screen display 300 shown in FIG. 3, the visual indicators 216A-216T have been selectively presented in order to convey to a user of the computer 102 the presence and direction of the undisplayed tabular data 108. In particular, the visual indicator 216C has been displayed at the top 222 of the column 208C to thereby indicate that undisplayed tabular data 108 exists in the direction of the top 222 of the column 208C. A visual indicator 216F has also been displayed to the right side 220 of the row 206A to thereby indicate that undisplayed tabular data 108 exists for the row 216A in the direction of the right side 220 of the row 206A. Similarly, a visual indicator 216G has been displayed to the right side 220 of the row 206B to indicate that undisplayed tabular data 108 exists for the row 206B in the direction of the right side 220 of the row 206B. A visual indicator 216Q has also been displayed to the left side 218 of the row 206D to thereby indicate that undisplayed tabular data 108 exists for the row 206D in the direction of the left side 218 of the row 206D.

It should be appreciated that by displaying the visual indicators 216A-216T for each row 206 or column 208 that has undisplayed tabular data 108 in the direction of the undisplayed tabular data, information can be communicated to a user of the computer 102 indicating not only that undisplayed tabular data 108 exists, but also communicating the direction of the undisplayed tabular data 108. It should be appreciated that the visual indicators 216A-216T are displayed only for those rows 206 or columns 208 having tabular data 108 that is not currently being displayed on screen.

In one implementation, only a single visual indicator is presented for each side of the data. For instance, a single visual indicator would be presented on the right side 220, a single visual indicator would be presented on the left side 218, a single visual indicator would be presented on the top 222, and a single visual indicator would be presented on the bottom 224. These indicators could be utilized to show that there is off-screen data in the respective direction and to indicate the presence of special off-screen data. These visual indicators could also be selected for navigating to the next off-screen data in the selected direction. This implementation might also be utilized with the per-column and per-row visual indicators described above.

As described briefly above, the data safety frame UI control 106 also provides functionality according to various embodiments for visually communicating to a user of the computer 102 that special tabular data exists that is not currently displayed on screen. Special tabular data might include error values, abnormal values, or any other type of value that should be specially called out to a user of the computer 102. The application program 104 might provide options for permitting a user to configure the types of data for which a special visual indicator should be provided.

In the screen display 300 shown in FIG. 3, a special visual indicator 304 has been displayed in order to communicate to a user of the computer 102 that special tabular data exists off-screen for the column 208B in the direction of the bottom 224 of the column 204B. It should be appreciated that special visual indicators 304 may also be displayed adjacent to the left side 218, the right side 220, and the top 222 to indicate the presence of special tabular data in those directions.

According to one implementation, the special visual indicator 304 also comprises an arrow pointing in the direction of the undisplayed special tabular data. In this embodiment, however, the special visual indicator 304 is colored in a manner to distinguish it from the visual indicators 216A-216T. It should be appreciated, however, that other mechanisms for highlighting the special visual indicator 304 may be utilized, such as the use of different shapes, different colors, animation, or other mechanisms. According to other embodiments, a special visual indicator 304 might be displayed in conjunction with a visual indicator 216 for rows or columns that have both undisplayed tabular data and undisplayed special tabular data.

As described briefly above, in addition to providing information regarding the presence and location of off-screen tabular data 108, the visual indicators 216 and the special visual indicators 304 also provide functionality for allowing a user of the computer 102 to navigate directly to the undisplayed tabular data 108. In particular, the visual indicators 216 and special visual indicators 304 may be selected through the use of an appropriate user input mechanism, such as the mouse cursor 302. Other types of user input mechanisms, such as keyboards and touch interfaces may also be utilized.

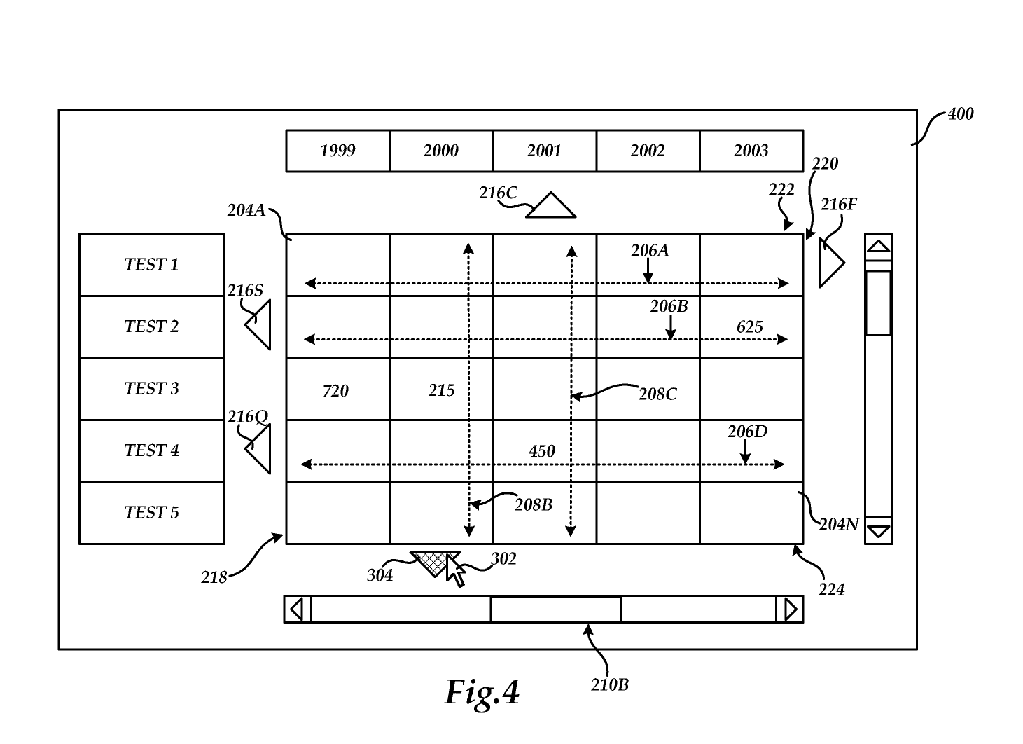

When one of the visual indicators 216 is selected, the data safety frame UI control 106 is configured to cause the application program 104 to display the next undisplayed tabular data 108 in the direction of the selected visual indicator 216. For instance, in the screen display 300 shown in FIG. 3, the mouse cursor 302 has been utilized to select the visual indicator 216G. In response thereto, the application program 104 is configured to modify the display of the tabular data 108 shown in the rows 206 and the columns 208 to include the next undisplayed tabular data 108 for the row 206B in the direction of the right side 220 of the row 206B. This is reflected in the screen display 400 shown in FIG. 4.

It should be appreciated that the selection of any visual indicator 216 will cause the application program 104 to display the undisplayed portion of the tabular data 108 corresponding to the row or column for which the visual indicator 216 was selected and in the direction of the selected visual indicator 216. In this manner, a user may utilize the visual indicators 216 to navigate directly to undisplayed tabular data 108 for a particular row 206 or column 208. It should be appreciated that after the display has been updated by the application program 104, the data safety frame UI control 106 will update the display of the visual indictors 216 and the special visual indicators 304 to reflect the existence of undisplayed tabular data 108 for the new location in the tabular data 108.

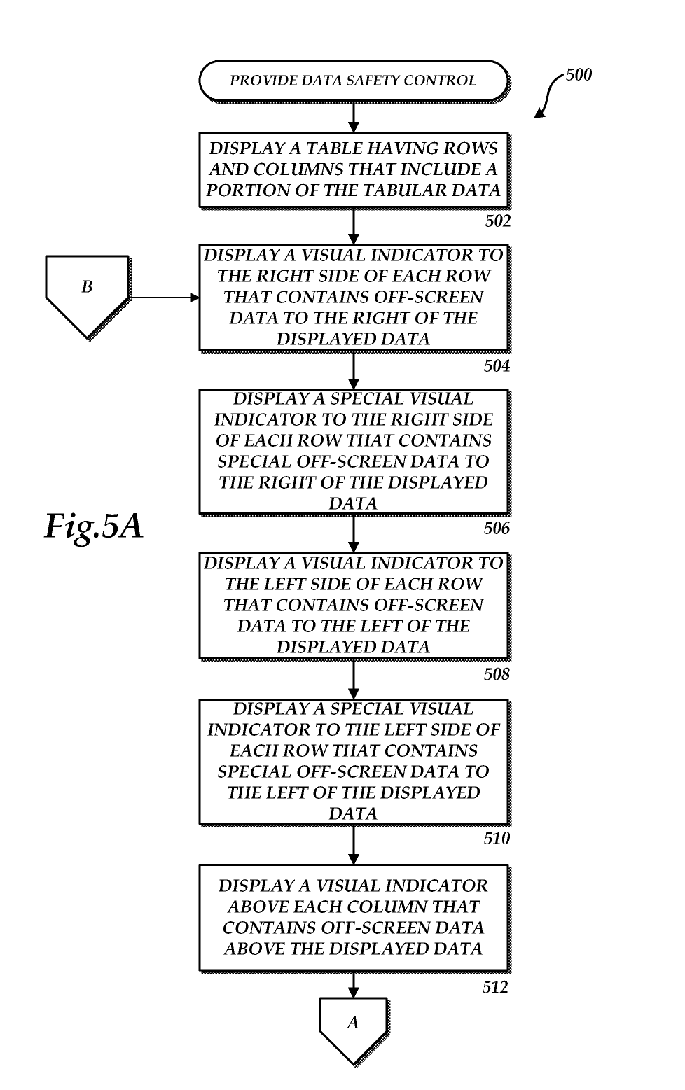

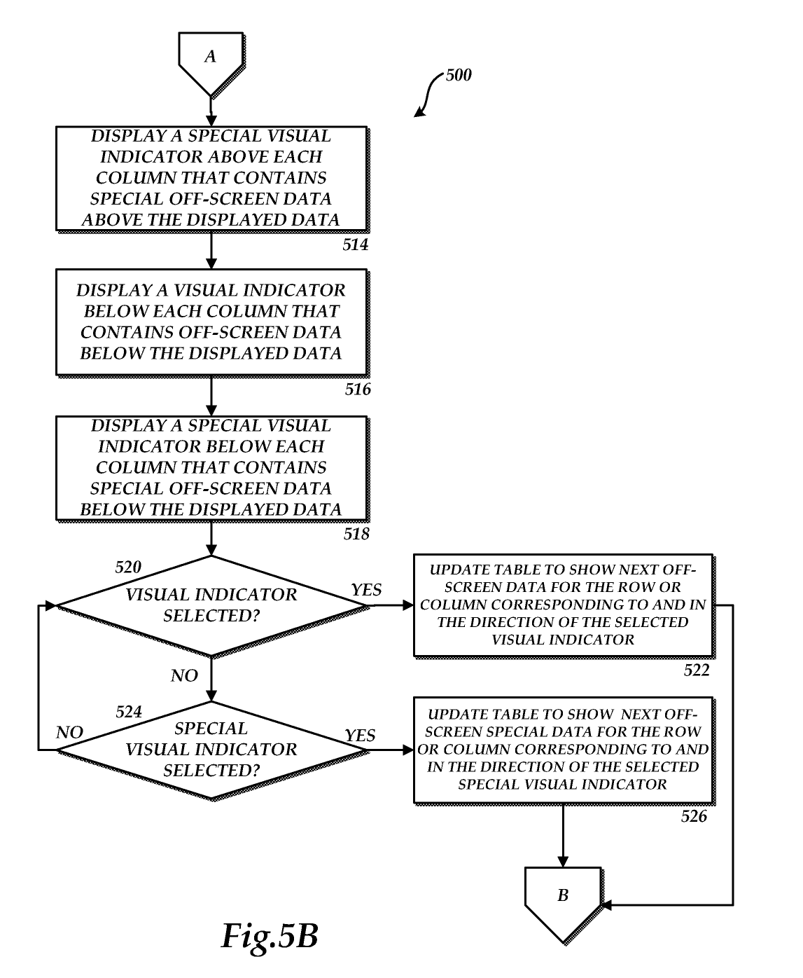

According to various embodiments, the special visual indicators 304 can be utilized to navigate to the special off-screen data. For instance, the special visual indicators 304 may be selected utilizing an appropriate user input mechanism, such as the mouse cursor 302. As an example, in response to receiving a selection of the special visual indicator 304, the data safety frame UI control 106 is configured to cause the application program 104 to display the next undisplayed special tabular data in the column 208B in the direction of the bottom 224 of the column 208B. In this manner, a user of the computer 102 may utilize the special visual indicator 304 to navigate directly to the next undisplayed special tabular data 108 present in the column 208B in the direction of the bottom 224 of the column 208B. It should be appreciated that special visual indicators 304 displayed at the left side 218, the right side 220, and the top 222 will cause the next special tabular data 108 present in the corresponding row or column in the selected direction to be displayed. Additional details regarding the functionality provided by the data safety frame UI control 106 will be provided below with respect to FIGS. 5A-5B.

Referring now to FIGS. 5A-5B, additional details will be provided regarding the embodiments presented herein for visualizing and navigating tabular data. In particular, FIGS. 5A-5B are flow diagrams showing a routine 500 that illustrates aspects of one process presented herein for visualizing and navigating tabular data using a data safety frame UI control 106.

It should be appreciated that the logical operations described herein with respect to FIGS. 5A-5B and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 500 begins at operation 502, where the application program 104 displays a table having rows 206 and columns 208 that include a portion of the tabular data 108. As discussed above, the application program 104 provides functionality for displaying a portion of the tabular data 108 and for allowing a user to navigate to the undisplayed portions of the tabular data 108 using the data safety frame UI control 106. Once a portion of the tabular data 108 has been displayed at operation 502, the routine 500 proceeds to operation 504.

At operation 504, the data safety frame UI control 106 displays a visual indicator 216 to the right side 220 of each row 206 that contains off-screen data to the right side 220 of the data displayed in the rows 206 and columns 208. From operation 504, the routine 500 proceeds to operation 506 where the data safety frame UI control 106 displays a special visual indicator 304 to the right side 220 of each row 206 the contains special tabular data off-screen to the right side 220 of the rows 206 and columns 208.

From operation 506, the routine 500 proceeds to operation 508 where the data safety frame UI control 106 displays a visual indicator 216 to the left side 218 of each row 206 that contains off-screen tabular data 108 to the left side 218 of the currently displayed data. The routine 500 then proceeds to operation 510 where the data safety frame UI control 106 displays a special visual indicator 304 to the left side 318 of each row 206 that contains special tabular data off-screen to the left side 218 of the displayed data.

From operation 510, the routine 500 proceeds to operation 512, where the data safety frame UI control 106 displays a visual indicator 216 toward the top 222 of each column 208 that contains off-screen tabular data 108 above the data displayed in the rows 206 and the columns 208. The routine 500 then proceeds to operation 514 where the data safety frame UI control 106 displays a special visual indicator 304 toward the top 222 of each column 208 that contains special tabular data off-screen above the top 222 of the rows 206 and columns 208.

From operation 514, the routine 500 proceeds to operation 516, where the data safety frame UI control 106 displays a visual indicator 216 adjacent to the bottom 224 of each column 208 that contains undisplayed tabular data 108 below the tabular data 108 displayed in the columns 208 and the rows 206. The routine 500 then proceeds to operation 518 where the data safety frame UI control 106 displays a special visual indicator 304 adjacent to the bottom 224 of each column 208 that contains special tabular data 108 below the tabular data 108 displayed in the rows 206 and columns 208.

From operation 518, the routine 500 proceeds to operation 520 where the data safety frame UI control 106 determines whether one of the visual indicators 216 has been selected. If so, the routine 500 proceeds to operation 522 where the data safety frame UI control 106 causes the application program 104 to update the contents of the rows 206 and columns 208 to show the next off-screen tabular data 108 for the row or column corresponding to, and in the direction of, the selected visual indicator 216. The data safety frame UI control 106 may then refresh the display of the visual indicators 216 and the special visual indicators 304 to reflect the new contents of the rows 206 and columns 208.

If, at operation 520 the data safety frame UI control 106 determines that one of the visual indicators 216 has not been selected, the routine 500 proceeds to operation 524. At operation 524, the data safety frame UI control 106 determines whether one of the special visual indicators 304 has been selected. If so, the routine 500 proceeds from operation 524 to operation 526, where the data safety frame UI control 106 causes the application program 104 to update the contents of the rows 206 and columns 208 to show a portion of the tabular data 108 that includes the next off-screen special tabular data 108 for the row or column corresponding to, and in the direction of, the selected special visual indicator 304. From operations 522 and 526, the routine 500 proceeds to operation 504, described above, where the data safety frame UI control 106 updates the display of the visual indicators 216 and the special visual indicators 304.

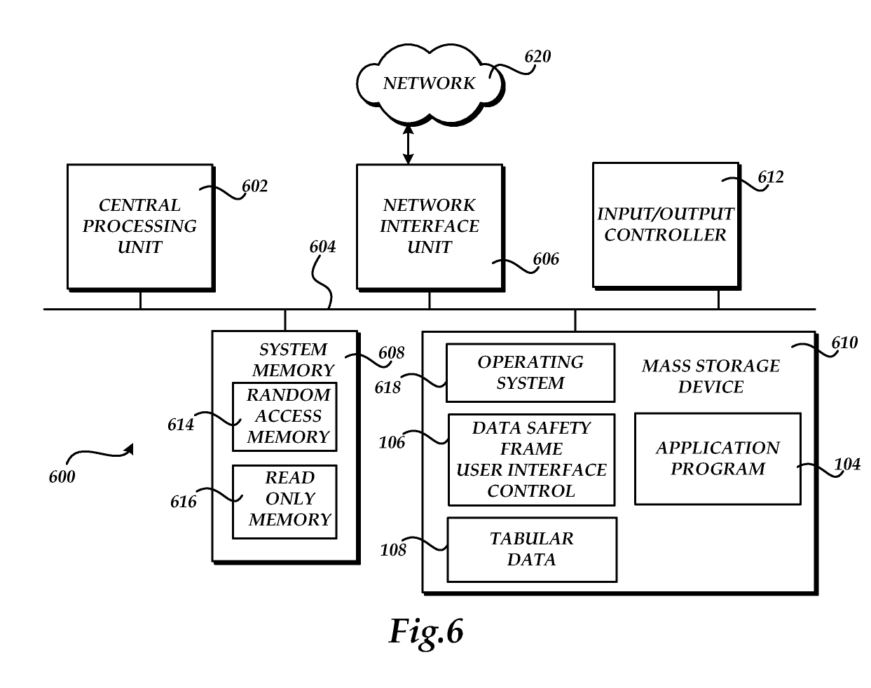

FIG. 6 shows an illustrative computer architecture for a computer 600 capable of executing the software components described herein for visualizing and navigating tabular data the manner presented above. The computer architecture shown in FIG. 6 illustrates a conventional desktop, laptop, or server computer and may be utilized to execute any aspects of the software components presented herein.

The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which are described in greater detail herein.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 620. The computer 600 may connect to the network 620 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system 618 suitable for controlling the operation of a networked desktop, laptop, or server computer. The mass storage device 610 and RAM 614 may also store one or more program modules. In particular, the mass storage device 610 and the RAM 614 may store the data safety frame UI control 106 and the application program 104, each of which was described in detail above with respect to FIGS. 1-5B. The mass storage device 610 and the RAM 614 may also store other types of program modules and data, including the tabular data 108.

It should be appreciated that the software components described herein may, when loaded into the CPU 602 and executed, transform the CPU 602 and the overall computer 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein may also transform the physical structure of the computer-readable media presented herein. The specific transformation of physical structure may depend on various factors, in different implementations of this description. Examples of such factors may include, but are not limited to: the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 600 in order to store and execute the software components presented herein. It also should be appreciated that the computer 600 may comprise other types of computing devices, including hand-held computers, embedded computer systems, personal digital assistants, and other types of computing devices known to those skilled in the art. It is also contemplated that the computer 600 may not include all of the components shown in FIG. 6, may include other components that are not explicitly shown in FIG. 6, or may utilize an architecture completely different than that shown in FIG. 6.

Based on the foregoing, it should be appreciated that technologies for visualizing and navigating tabular data using a data safety frame UI control 106 are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for visualizing and navigating tabular data, the computer-implemented method comprising performing computer-implemented operations for:
displaying a portion of the tabular data in a plurality of rows and a plurality of columns, each row having a left side and a right side and each column having a top and a bottom;
displaying a visual indicator adjacent to the right side of each row having undisplayed tabular data in the row in the direction of the right side of the row;
displaying a visual indicator adjacent to the left side of each row having undisplayed tabular data in the row in the direction of the left side of the row;
displaying a visual indicator adjacent to the top of each column having undisplayed tabular data in the column in the direction of the top of the column; and
displaying a visual indicator adjacent to the bottom of each column having undisplayed tabular data in the column in the direction of the bottom of the column.

2. The computer-implemented method of claim 1, further comprising:
receiving a selection of a visual indicator displayed adjacent to the right side of a row; and
in response to receiving the selection, displaying a portion of the tabular data in the rows and columns that includes the undisplayed tabular data in the row in the direction of the right side of the row for the row corresponding to the selected visual indicator.

3. The computer-implemented method of claim 1, further comprising:
receiving a selection of a visual indicator displayed adjacent to the left side of a row; and
in response to receiving the selection, displaying a portion of the tabular data in the rows and columns that includes the undisplayed tabular data in the row in the direction of the left side of the row for the row corresponding to the selected visual indicator.

4. The computer-implemented method of claim 1, further comprising:
receiving a selection of a visual indicator displayed adjacent to the top of a column; and
in response to receiving the selection, displaying a portion of the tabular data in the rows and columns that includes the undisplayed tabular data in the column in the direction of the top of the column for the column corresponding to the selected visual indicator.

5. The computer-implemented method of claim 1, further comprising:
receiving a selection of a visual indicator displayed adjacent to the bottom of a column; and
in response to receiving the selection, displaying a portion of the tabular data in the rows and columns that includes the undisplayed tabular data in the column in the direction of the bottom of the column for the column corresponding to the selected visual indicator.

6. The computer-implemented method of claim 1, further comprising:
displaying a special visual indicator adjacent to the right side of each row having undisplayed special tabular data in the row in the direction of the right side of the row;
displaying a special visual indicator adjacent to the left side of each row having undisplayed special tabular data in the row in the direction of the left side of the row;
displaying a special visual indicator adjacent to the top of each column having undisplayed special tabular data in the column in the direction of the top of the column; and
displaying a special visual indicator adjacent to the bottom of each column having undisplayed special tabular data in the column in the direction of the bottom of the column.

7. The computer-implemented method of claim 6, further comprising:
receiving a selection of a special visual indicator displayed adjacent to the right side of a row; and
in response to receiving the selection of the special visual indicator, displaying a portion of the tabular data in the rows and columns that includes the undisplayed special tabular data in the row in the direction of the right side of the row for the row corresponding to the selected visual indicator.

8. The computer-implemented method of claim 6, further comprising:
receiving a selection of a special visual indicator displayed adjacent to the left side of a row; and
in response to receiving the selection of the special visual indicator, displaying a portion of the tabular data in the rows and columns that includes the undisplayed special tabular data in the row in the direction of the left side of the row for the row corresponding to the selected visual indicator.

9. The computer-implemented method of claim 6, further comprising:
receiving a selection of a special visual indicator displayed adjacent to the top of a column; and
in response to receiving the selection of the special visual indicator, displaying a portion of the tabular data in the rows and columns that includes the undisplayed special tabular data in the column in the direction of the top of the column for the column corresponding to the selected visual indicator.

10. The computer-implemented method of claim 6, further comprising:
receiving a selection of a special visual indicator displayed adjacent to the bottom of a column; and
in response to receiving the selection of the special visual indicator, displaying a portion of the tabular data in the rows and columns that includes the undisplayed special tabular data in the column in the direction of the bottom of the column for the column corresponding to the selected visual indicator.

11. The computer-implemented method of claim 10, wherein the special tabular data comprises an error value.

12. The computer-implemented method of claim 10, wherein the special tabular data comprises an abnormal value.

13. A computer-readable storage medium having computer-readable instructions stored thereupon which, when executed by a computer, cause the computer to:
display a portion of tabular data in a plurality of rows and a plurality of columns, each row having a left side and a right side and each column having a top and a bottom;
display a visual indicator adjacent to the right side of each row having undisplayed tabular data in the row in the direction of the right side of the row, display a visual indicator adjacent to the left side of each row having undisplayed tabular data in the row in the direction of the left side of the row, display a visual indicator adjacent to the top of each column having undisplayed tabular data in the column in the direction of the top of the column, and display a visual indicator adjacent to the bottom of each column having undisplayed tabular data in the column in the direction of the bottom of the column;
receive a selection of a visual indicator; and
in response to receiving the selection of the visual indicator, to display a portion of the tabular data in the rows and columns that includes the undisplayed tabular data for the row or column corresponding to the selected visual indicator in the direction of the selected visual indicator.

14. The computer-readable storage medium of claim 13, having further computer-executable instructions stored thereupon which, when executed by the computer, cause the computer to display a special visual indicator adjacent to the right side of each row having undisplayed special tabular data in the row in the direction of the right side of the row, display a special visual indicator adjacent to the left side of each row having undisplayed special tabular data in the row in the direction of the left side of the row, display special visual indicator adjacent to the top of each column having undisplayed special tabular data in the column in the direction of the top of the column, and to display a special visual indicator adjacent to the bottom of each column having undisplayed special tabular data in the column in the direction of the bottom of the column.

15. The computer-readable storage medium of claim 14, having further computer-executable instructions stored thereupon which, when executed by the computer, cause the computer to:
receive a selection of a special visual indicator; and
in response to receiving the selection of the special visual indicator, to display a portion of the tabular data in the rows and columns that includes the undisplayed special tabular data for the row or column corresponding to the selected special visual indicator in the direction of the selected special visual indicator.

16. The computer-readable storage medium of claim 15, wherein the special tabular data comprises an error value.

17. The computer-readable storage medium of claim 16, wherein the special tabular data comprises an abnormal value.

18. A computer-readable storage medium having computer-readable instructions stored thereupon which, when executed by a computer, cause the computer to:
display a portion of tabular data in a plurality of rows and a plurality of columns, each row having a left side and a right side and each column having a top and a bottom;
for each row, to display a visual indicator adjacent to the right side of each row having undisplayed tabular data in the row in the direction of the right side of the row or display a special visual indicator adjacent to the right side of each row having undisplayed special tabular data in the row in the direction of the right side of the row and display a visual indicator adjacent to the left side of each row having undisplayed tabular data in the row in the direction of the left side of the row or display a special visual indicator adjacent to the left side of each row having undisplayed special tabular data in the row in the direction of the left side of the row;
for each column, to display a visual indicator adjacent to the top of each column having undisplayed tabular data in the column in the direction of the top of the column or display a special visual indicator adjacent to the top of each column having undisplayed special tabular data in the column in the direction of the top of the column and display a visual indicator adjacent to the bottom of each column having undisplayed tabular data in the column in the direction of the bottom of the column or display a special visual indicator adjacent to the bottom of each column having undisplayed special tabular data in the column in the direction of the bottom of the column;
receive a selection of a visual indicator or a special visual indicator;
in response to receiving the selection of a visual indicator, to display a portion of the tabular data in the rows and columns that includes the undisplayed tabular data for the row or column corresponding to the selected visual indicator in the direction of the selected visual indicator; and
in response to receiving the selection of a special visual indicator, to display a portion of the tabular data in the rows and columns that includes the undisplayed special tabular data for the row or column corresponding to the selected special visual indicator in the direction of the selected special visual indicator.

19. The computer-readable storage medium of claim 18, wherein the special tabular data comprises an error value.

20. The computer-readable storage medium of claim 19, wherein the special tabular data comprises an abnormal value.
